(19) United States
(12) Patent Application Publication
(10) Pub. No.: US 2025/0061737 A1
(43) Pub. Date: Feb. 20, 2025

(54) METHOD AND SYSTEM FOR MANAGING APPLICATIONS USING ARTIFICIAL INTELLIGENCE (AI)

(71) Applicant: HCL Technologies Limited, New Delhi (IN)

(72) Inventors: HIRANSHA MANGATTUPARAMBIL, Chennai (IN); SRINIVAS TANGIRALA, Hyderabad (IN); SRIHARI VARADHARAJAN, Chennai (IN); NARENDER SIDDHAMSHETTY, Hyderabad (IN); KIRAN AYYAGARI, Hyderabad (IN)

(21) Appl. No.: 18/633,589

(22) Filed: Apr. 12, 2024

(30) Foreign Application Priority Data
Aug. 17, 2023 (IN) 202311055229

(51) Int. Cl. G06V 30/30; G06F 16/957; G06F 16/958; G06V 30/14; G06V 30/148; G06V 30/19; G06V 30/416; G06V 30/42

(52) U.S. Cl. CPC G06V 30/30; G06F 16/9577; G06F 16/958; G06V 30/1444; G06V 30/153; G06V 30/191; G06V 30/416; G06V 30/42

(57) ABSTRACT

This disclosure relates to a method and a system for managing applications. The method includes identifying a text label from a testcase and a real-time image associated with an application. The application is one of the mobile application or a web application. The method further includes determining a positioning of each of a set of web elements within the real-time image. The method further includes mapping the text label to a web element from the set of web elements based on the determined positioning using a mapping algorithm. The text label is mapped to the web element based on a corresponding set of attributes. The method further includes generating a segmented image comprising the text label and the web element, upon mapping; and transmitting the segmented image to a testing unit for performing an action associated with the text label and the web element.

### TECHNICAL FIELD

This disclosure relates generally to Artificial Intelligence, and more particularly to method and system for managing application using AI.

### BACKGROUND

In today's world, new technologies are growing at a rapid rate, leading to the development of various mobile and desktop applications for online and offline platforms. Every application has a User Interface (UI) that provides look, feel and accessibility to users of the application. Due to this, the importance of the UI testing has increased, where the application including the UI undergoes comprehensive validations before deploying to production or live environment. The UI testing helps to know whether the UI functionality of each object or web element for an application is performing in an expected way. Currently, majority of the UI testing is performed using test automation frameworks available in the market. To implement the desired actions in this type of test automation frameworks may require certain programming skills or technical knowledge. These test automation frameworks use element locator information such as id, name, class, CSS selector, linktext or Xpath, etc., to interact with the web elements of the application for validation purposes. The attributes information, i.e., the element locator information is either manually taken by the user (i.e., a tester) or with the help of existing software tools and updated to test scripts, object classes, or templates for accessing the web elements.

However, there are challenges in extracting the element locator information of a web element using existing techniques, as usage of these existing techniques for extracting such information mostly depends on technical expertise of the user to construct path of a unique element locator. In complex scenarios it is an intricate process to get the element locator information, as in such cases identification of the path of the unique element locator may involve manual efforts and time delay. For example, in case the application UI having dynamic web elements, graphs, nested iFrames, maps, web elements with common attributes, etc., requires construction of the path for the unique element locator upfront which is a big challenge. Moreover, this is a repetitive task, whenever a new web element is added to the existing application UI then it requires manual efforts to construct or update the element locator information in the test scripts or templates. Thus, the exiting techniques in the present state of art fails to address the problem of identification of web elements within the application.

### SUMMARY

In one embodiment, a method for managing applications is disclosed. In one example, the method may include identifying, by a trained Artificial Intelligence (AI) model, a text label from a test case and a real-time image associated with an application. It may be noted that the application is one of the mobile application or a web application. The method may further include determining, by the trained AI model, a positioning of each of a set of web elements within the real-time image. The method may further include mapping, by the trained AI model, the text label to a web element from the set of web elements based on the determined positioning using a mapping algorithm. It may be noted that the text label is mapped to the web element based on a corresponding set of attributes. The method may further include generating, by the trained AI model, a segmented image including the text label and the web element, upon mapping. The method may further include transmitting, by the trained AI model, the segmented image to a testing unit for performing an action associated with the text label and the web element.

In another embodiment, a system for managing applications is disclosed. The system may include a processor and a memory communicatively coupled to the processor. The memory may store processor-executable instructions, which, on execution, may cause the processor to identify, by a trained Artificial Intelligence (AI) model, a text label from a testcase and a real-time image associated with an application. It may be noted that the application is one of the mobile application or a web application. The processor-executable instructions, on execution, may further cause the processor to determine, by the trained AI model, a positioning of each of a set of web elements within the real-time image. The processor-executable instructions, on execution, may further cause the processor to map, by the trained AI model, the text label to a web element from the set of web elements based on the determined positioning using a mapping algorithm. It may be noted that the text label is mapped to the web element based on a corresponding set of attributes. The processor-executable instructions, on execution, may further cause the processor to generate, by the trained AI model, a segmented image including the text label and the web element, upon mapping. The processor-executable instructions, on execution, may further cause the processor to transmit, by the trained AI model, the segmented image to a testing unit for performing an action associated with the text label and the web element.

In yet another embodiment, a non-transitory computer-readable medium storing computer-executable instructions for managing applications is disclosed. The stored instructions, when executed by a processor, may cause the processor to perform operations including identifying, by a trained Artificial Intelligence (AI) model, a text label from a testcase and a real-time image associated with an application. It may be noted that the application is one of the mobile application or a web application. The operations may further determine, by the trained AI model, a positioning of each of a set of web elements within the real-time image. The operations may further include mapping, by the trained AI model, the text label to a web element from the set of web elements based on the determined positioning using a mapping algorithm. It may be noted that the text label is mapped to the web element based on a corresponding set of attributes. The operations may further include generating, by the trained AI model, a segmented image including the text label and the web element, upon mapping. The operations may further include transmitting, by the trained AI model, the segmented image to a testing unit for performing an action associated with the text label and the web element.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system configured for managing applications, in accordance with some embodiments of the present disclosure.

FIG. 2 illustrates a functional block diagram of various modules within a memory of a computing device configured for managing applications, in accordance with some embodiments of the present disclosure.

FIG. 3 illustrates a flow diagram of an exemplary process for managing applications, in accordance with some embodiments of the present disclosure.

FIG. 4 illustrates a flow diagram of an exemplary process for identifying a text label, in accordance with some embodiments of the present disclosure.

FIG. 5 illustrates a flow diagram of an exemplary process of selecting a real-time image, in accordance with some embodiments of the present disclosure.

FIGS. 6A-6B represents graphical user interfaces (GUIs) depicting generation of a segmented image, in accordance with an exemplary embodiment of the present disclosure.

FIGS. 7A-7B represents GUIs depicting generation of a segmented image, in accordance with another exemplary embodiment of the present disclosure.

FIG. 8 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

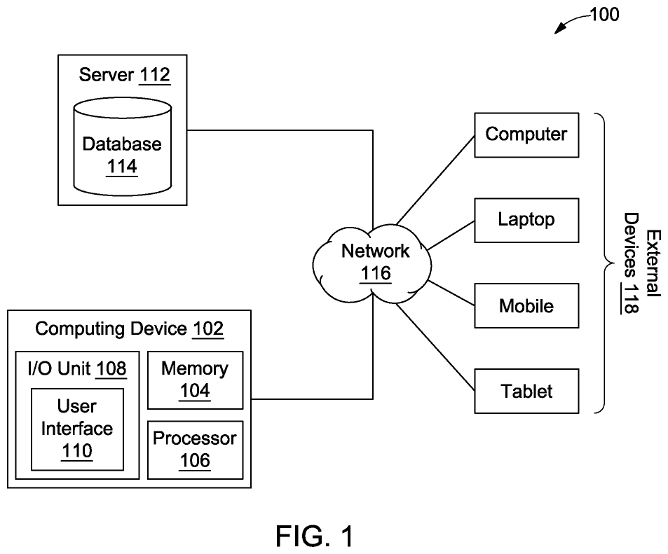

Referring now to FIG. 1, a block diagram of an exemplary system 100 configured for managing applications is illustrated, in accordance with some embodiments of the present disclosure. As depicted via the present FIG. 1, the system 100 may include a computing device 102. The computing device 102 may be configured to manage applications. As will be appreciated, the applications may be one of a web application or a mobile application. Further, for ease of explanation, managing of one application is explained. However, this similar technique may be used to manage any number of applications. In order to manage the application, the computing device 102 may include a trained Artificial Intelligence (AI) model. The trained AI model may be stored within a memory 104 of the computing device 102.

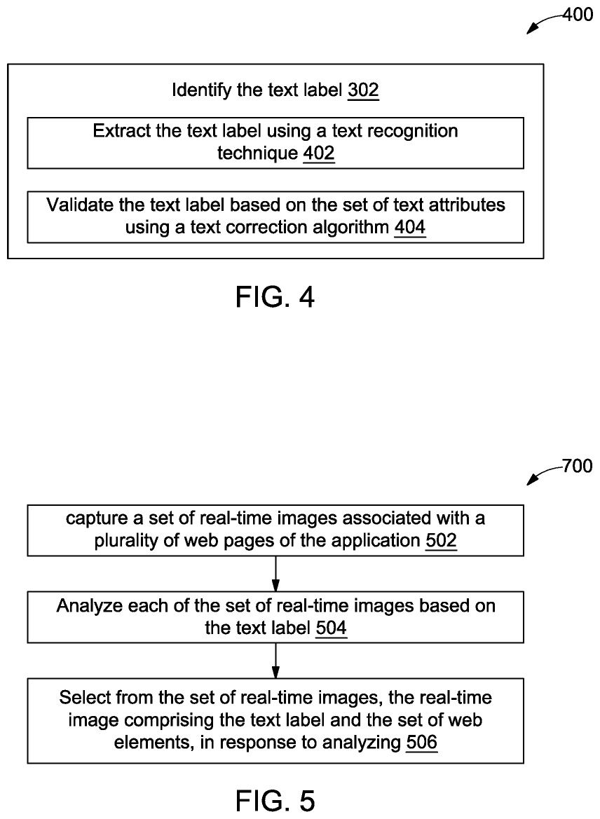

In order to manage the application, initially, the trained AI model may be configured to receive a test case associated with the application. Upon receiving the test case, the trained AI model may be configured to identify a text label from the test case. In an embodiment, the text label may be identified based on a user input received corresponding to the text label. For example, the user input may be a name of the text label, e.g., ‘username’. Further, the trained AI model may be configured to identify the text label with a real-time image associated with the application. In an embodiment, the real-time image may be selected from a plurality of images associated with the application. A method of identifying the text label has been further explained in detail in conjunction with FIG. 4.

Once the test label is identified, then the trained AI model may be configured to determine a positioning of each of a set of web elements within the real-time image. In other words, the position of each web element present within the real-time images may be determined. Examples of the set of web elements may include, but is not limited to, an icon, a button, a dropdown list, a checkbox, a text field, a text box, a radio button, a calendar, a text area, and text links. Upon identifying the text label and the position of each web element, the trained AI model may be configured to map the text label to a web element from the set of web elements. The text label may be mapped to the web element based on the determined positioning using a mapping algorithm. In an embodiment, the text label may be mapped to the web element based on a corresponding set of attributes. The set of attributes may include a set of text attributes and a set of web elements attributes.

Further, the trained AI model may be configured to generate a segmented image, in response to mapping the text label with the web element. The segmented image may include the text label with the web element. Once the segmented image is generated, the trained AI model may be configured to transmit the segment image to a testing unit. The testing unit may utilize the segmented image for performing an action associated with the text label and the web element. The testing unit may correspond to a test automation framework. As will be appreciated, the test automation framework may correspond to any framework that supports automated testing of the application (i.e., the mobile application or the web application). Further, in some embodiment, the testing unit may be part of the computing device 102. Furthermore, in some another embodiment, the testing unit may be part of any external computing device, such as external devices 118.

Examples of the computing device 102 may include, but is not limited to, a mobile phone, a laptop, a desktop, or a PDA, an application server, and so forth. The computing device 102 may further include the memory 104, a processor 106, and the Input/Output unit 108. The I/O unit 108 may further include a user interface 110. A user or an administrator may interact with the computing device 102 and vice versa through the I/O unit 108.

The I/O unit 108 may be used to display results (i.e., the identified text label, the positioning of the web element, the segmented image etc.) based on actions performed by the computing device 102, to the user. The user interface 110 may be used by the user to provide inputs to the computing device 102. Thus, for example, in some embodiment, the computing device 102 may ingest an input that includes the user input corresponding to the text label, the application required to be managed, the test case (also referred as test script). Further, in some another embodiment, the computing device 102 may ingest an input that includes the real-time image of the application. Further, for example, in some embodiments, the computing device 102 may render intermediate results (e.g., the identified text label, the positioning of the web element) or final results (e.g., the segmented image) to the user via the user interface 110.

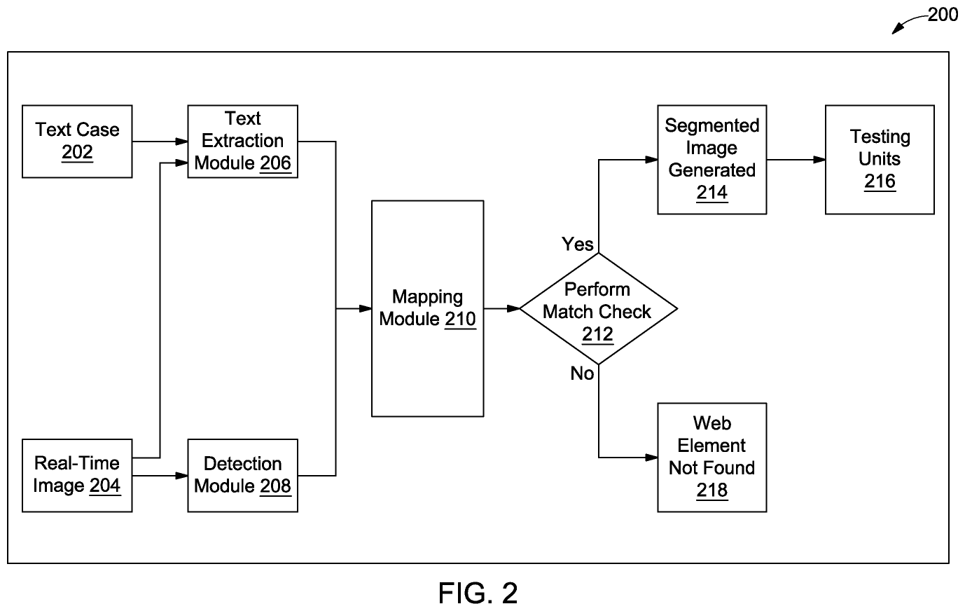

The memory 104 may store instructions that, when executed by the processor 106, may cause the processor 106 to manage the applications. As will be described in greater detail in conjunction with FIG. 2 to FIG. 7B, in order to manage the application, the processor 106 in conjunction with the memory 104 may perform various functions including identifying the text label, determining the positioning of the set of web elements, mapping the text label to the web element, generating the segmented image, transmitting the segmented image to the testing unit, etc.

The memory 104 may also store various data (e.g., the text label, the positioning of each of the set of web elements, the set of text attributes, the set of web element attributes, the segmented image, and the like) that may be captured, processed, and/or required by the computing device 102. The memory 104 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.).

Further, the computing device 102 may interact with the server 112 or external device 118 over a network 116 for sending and receiving various data. The network 116, for example, may be any wired or wireless communication network and the examples may include, but may be not limited to, the Internet, Wireless Local Area Network (WLAN), Wi-Fi, Long Term Evolution (LTE), Worldwide Interoperability for Microwave Access (WiMAX), and General Packet Radio Service (GPRS).

In an embodiment, the computing device 102 may fetch information regarding the application from the server 112. In addition, the server 112 may provide information, such as details about the text label and the set of web elements to the user. The server 112 may further include a database 114. By way of an example, the database 114 may store information regarding one or more existing applications. The database 114 may be periodically updated based on a new application. Alternatively, the computing device 102 may receive input from the user from one of the external devices 118. This complete process followed by the system 100 is further explained in detail in conjunction with FIG. 2 to FIG. 8.

Referring now to FIG. 2, a functional block diagram of various modules within the memory 104 of the computing device 102 configured to manage applications, in accordance with some embodiments of the present disclosure. FIG. 2 is explained in conjunction with FIG. 1. As mentioned in FIG. 1, the memory 104 may include the trained AI model. The trained AI model may include a text extraction model 206, an element detection module 208, and a mapping module 210. As will be appreciated, the trained AI model may correspond to a deep learning model (e.g., a region-based convolution neural network (R-CNN)).

Initially, a testcase 202 (may be provided as an input to the text extraction module 206. The testcase 202 may be a test case document. Other examples of the testcase 202 may be a test script of a template. In case of a scriptless, behavior-driven development (BDD) type of automation frameworks test cases documents or templates may be provided as an input. In an embodiment, the testcase 202 may be provided as input by a user (e.g., a tester). In some embodiment, in addition to the testcase 202, the text extraction module 206 may be configured to receive a user input corresponding to the text label, such as ‘text label name’ from the user. The text extraction module 206 may be configured to read test step from the test case 202. The text extraction module 206 may read the test steps to search for the text label present within the testcase 202. Further, the text extraction module 206 may be configured to extract the text label from the testcase 202.

Once the text label is extracted from the testcase 202, then the text extraction module 206 may be configured to identify the text label within a real-time image 204. In an embodiment, the real-time image 204 may be selected from a set of real-time images based on the text label. In an embodiment, each real-time image of the set of real-time images may be associated with a corresponding web page of a plurality of web pages associated with the application. It should be noted that each real-time image of the set of real-time images may be captured based on the test steps within the testcase 202. In some embodiment, only one real-time image including the text label may be captured and processed at a time.

Further, in order to identify the text label from the real-time image 204, the text extraction module 206 may be configured to analyze each of a set of text labels present within the real-time image 204. In an embodiment, each of the set of text labels may be analyzed irrespective of a set of text attributes associated with each of the set of text labels. The set of text attributes may include, but is not limited to, an orientation of the text label, an alignment of the text label, font size, font color, and font style. The text extraction module 26 may then extract the text label from the real-time image 204.

Further, upon extracting the text label, the text extraction module 206 may be configured to validate the text label based on the set of text attributes. The validation of the text label may be done using a text correction algorithm. The validation of the text label using the text correction algorithm may be done to ensure that the extracted text label is a correct text label. In other words, the text extraction module 206 may identify a correct text label from the text case 202 and the real-time image 204, even if there is any minute difference between the user input and the identified text label. For example, the text label identified from the test case 202 may have one or more phrases for a web element that will be oriented in two rows within the real-time image 202 which need to be identified as single text label. In this case, the text extraction module 206 may be able to correctly identify the text label using the text correction algorithm. The text extraction module 206 may be configured to send the text label to the mapping module 210.

Once the text label is identified from the testcase 202 and the real-time image 204, then a web element corresponding to the text label may be identified. In order to identify the corresponding web element, the element detection module 208 may be configured to process the real-time image 204 to detect each of the set of web elements present within the real-time image 204. In particular, the element detection module 208 may determine a positioning (i.e., the position) of each of the set of web elements within the real-time image 202.

Examples of the set of web elements may include an icon, a button, a dropdown list, a checkbox, a text field, a text box, a radio button, a calendar, a text area, text links, and the like. As will be appreciated, the detection module 208 may be configured to detect a correct position of each of the set of web elements irrespective of a set of web elements attributes associated with each of the set of web elements. The set of web element attributes may include, a type of the web element, an alignment of the web element, an orientation of the web element, a size of the web element, a shape of the web element, number of blocks within the web element, background of the real-time image 204 including the web element. Further, the positioning information of each web element, for example may include coordinates of web elements, orientation of the web-element, alignment of the web element, and the like.

For example, a web element for a credit card may have multiple boxes or blocks to receive card information (i.e., the credit card number) that must be considered as one entity (box). In such cases, the detection module 208 may process the real-time image 204 (i.e., a multi-dimension image) in all standard file formats and detect all web elements present within the real-time image 204. Once all the web elements present within the real-time image are detected, then a web element corresponding to the credit card number may be successfully identified from all the web elements present within the real-time image 204, irrespective of the background of the real-time image 204. The detection module 208 may be configured to send the positioning determined of each of the set of web elements to the mapping module 210.

The mapping module may be configured to receive the text label and the positioning of each of the set of web elements from the text extraction module 206 and the element detection module 208 respectively. Further, the mapping module 206 may be configured to map the text label to the corresponding web element from the set of web elements. The mapping of the text label with the corresponding web element may be done using a mapping algorithm based on the positioning determined of each of the set of web elements.

The mapping module 210 may be configured in such a way that it is able to understand dynamics of each web element within the real-time image 204. Further, the mapping module 210 may be configured to diligently map the text label to the corresponding web element. The mapping module 210 may map the text label to the corresponding web element based on the corresponding set of attributes, i.e., the set of text attributes, and the set of web element attributes. By way of example, the mapping module 210 may be able to accurately recognize the text label is present inside the web element in shadowed or inactive mode like search text box, date, year, password box etc., using the mapping algorithm.

Once the text label is mapped to the corresponding web element, then a check may be performed at 212. The check may be performed to determine whether the web element mapped to the text label is correct or not. In one embodiment, when the web element mapped to the text label is correct, then at 214, a segment image may be generated. The segmented image may include the text label and the corresponding web element. Further, at 216, the segment image may be provided as an input to a testing unit 216. The testing unit may correspond to a test automation framework. Further, in another embodiment, when the web element mapped to the text label is incorrect, then at 218, a notification ‘web element not found’ may be rendered to the user.

It should be noted that all such aforementioned modules 206-210 may be represented as a single module or a combination of different modules. Further, as will be appreciated by those skilled in the art, each of the modules 206-210 may reside, in whole or in parts, on one device or multiple devices in communication with each other. In some embodiments, each of the modules 206-210 may be implemented as dedicated hardware circuit comprising custom application-specific integrated circuit (ASIC) or gate arrays, off-the-shelf semiconductors such as logic chips, transistors, or other discrete components. Each of the modules 206-210 may also be implemented in a programmable hardware device such as a field programmable gate array (FPGA), programmable array logic, programmable logic device, and so forth. Alternatively, each of the modules 206-210 may be implemented in software for execution by various types of processors (e.g., processor 106). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for managing applications. For example, the exemplary system 100 and the associated computing device 102, including the trained AI model may manage application by the processes discussed herein. In particular, as will be appreciated by those of ordinary skill in the art, control logic and/or automated routines for performing the techniques and steps described herein may be implemented by the system 100 and the associated computing device 102 including the trained AI model, either by hardware, software, or combinations of hardware and software. For example, suitable code may be accessed and executed by the one or more processors on the system 100 to perform some or all of the techniques described herein. Similarly, application specific integrated circuits (ASICs) configured to perform some, or all of the processes described herein may be included in the one or more processors on the system 100.

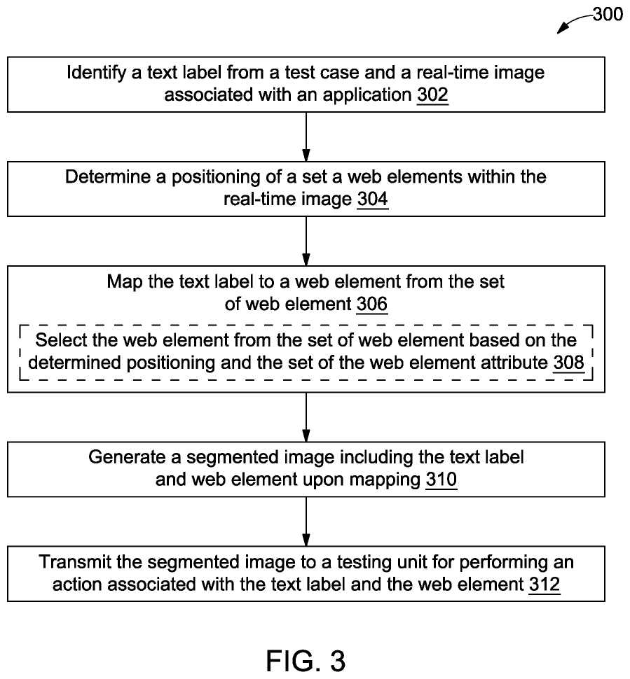

Referring now to FIG. 3, a flow diagram of an exemplary process 300 for managing applications is depicted via a flowchart, in accordance with some embodiments of the present disclosure. FIG. 3 is explained in conjunction with FIGS. 1 and 2. Further, each step of the process 300 may be implemented by various modules of the trained Artificial model (AI) present within the memory 104 of the computing device 102 of the system 100.

At step 302, a text label may be identified from a testcase, and a real-time image associated with an application. The application may be one of a mobile application or a web application. As will be appreciated, the text label associated with the application may be identified by reading the test steps from the testcase. In an embodiment, the text label may be identified using a text recognition technique and a text correction technique. With reference to FIG. 2, the text label may be identified by the text extraction module 206. A method of identifying a text label is further explained in detail in conjunction with FIG. 4.

Once the text label is identified, then at step 304, a positioning of each of a set of web elements within the real-time image may be determined. In an embodiment, the positioning of each of the set of web elements may be determined using an element locating technique. With reference to FIG. 2, the positioning of each of the set of web elements may be determined by the detection module 208. Further, at step 306, the text label may be mapped to a web element from the set of web elements. The mapping of the text label to the web element may be done based on the determined positioning using a mapping algorithm.

Further, in order to map the text label to the web element, at step 308, the web element may be selected from the set of web elements. The web element may be selected based on the positioning determined of each of the set of web elements and the set of web element attributes associated with the each of the set of web elements. In an embodiment, the positioning of the selected web element may be within a Region of Interest (ROI) of the text label.

In an embodiment, the text label may be mapped with the web element based on a corresponding set of attributes. The corresponding set of attributes may include a set of text attributes and a set of web elements attributes. Further, the set of text attributes associated with the text label may include an orientation of the text label, font size, font color, and font style. In addition, the set of web elements attributes may include the type of the web element, an alignment of the web element, an orientation of the web element, a size of the web element, a shape of the web element, number of blocks within the web element, background of the real-time image comprising the web element. With reference to FIG. 2, the text label may be mapped to the web element by the mapping module 210.

Once the web element corresponding to the text label is selected and mapped, the at step 310, a segmented image may be generated. The segmented image may include the text label and the web element. Further, at step 310, the segmented image may be transmitted to a testing unit for performing an action associated with the text label and the web element. The testing unit may correspond to a test automation framework that is used for testing functionalities of any web application or the mobile application. It should be noted that the segmented image may be saved in the name of the text label within a repository (e.g., the database 114). Once the segment image is saved, then the segment image may be transmitted to the test automation framework based requirements of the testcase, for future executions.

Referring now to FIG. 4, a flow diagram of an exemplary process 400 for identifying a text label is depicted via a flowchart, in accordance with some embodiments of the present disclosure. FIG. 4 is explained in conjunction with FIGS. 1-3. Each step of the process 400 may be implemented by the trained AI model present within the memory 104 of the computing device 102.

With reference to FIG. 3, in order to identify the text label as mentioned via step 302, initially, the testcase may be analyzed. The testcase may be analyzed to read test steps within the testcase. As will be appreciated, each test step with the testcase may include the text label. Further, based on the reading, at step 402, the text label may be extracted from the text case. In an embodiment, the testcase may be analyzed using a text recognition technique. The text recognition technique may be, for example, an optical character recognition technique.

Further, in addition to identification of the text label from the testcase as mentioned via step 402, at step 402, the text label may be extracted from the real-time image. In order to extract the text label from the real-time image, content within the real-time image may be analyzed using the text recognition technique. In other words, the content within the real-time image may be analyzed to search for the text label within the real-time image. It should be noted that the text label may be identified by reading the test steps present within the testcase. Moreover, the real-time image including the text label may be selected from a set of real-time images associated with the application. A method of selecting the real-time image is further explained in detail in conjunction with FIG. 5.

Once the text label may be identified from the testcase and the real-time image, then at step 404, the text label may be validated based on the set of text attributes. In an embodiment, the text label may be validated using a text correction algorithm. The text correction algorithm may be able to validate the extracted text label irrespective of the set of text attributes associated with the text label. The set of text attributes, for example, may include an orientation of the text label, an alignment of the text label, font size, font color, and font style, and the like.

Referring now to FIG. 5, a flow diagram of an exemplary process 500 of identifying a real-time image associated with an application is depicted via a flowchart, in accordance with some embodiments of the present disclosure. FIG. 5 is explained in conjunction with FIGS. 1-4. Each step of the process 500 may be implemented using the trained AI model present within the memory 104 of the computing device 102. With reference to FIG. 3, in order to identify the real-time image, initially at step 502, a set of real-time images may be captured. In an embodiment, each of the set of real-time images may be associated with a plurality of web pages of the application. As will be appreciated, each of the set of real-time images may be automatically captured using the computing device 102. Moreover, each of the set of real-time images may be captured based on the test steps within the testcase. In particular, the capturing of each of the set of real-time images may be performed based on an action defined in a corresponding test step within the testcase. In some embodiment, each test step of the testcase document may include a new text label based on which only one real-time image including a corresponding text label may be captured and processed at a time. In other words, each real-time image including the corresponding text label present within the testcase may be captured and processed sequentially based on sequence of the text label within the test steps of the testcase.

Further, upon capturing the set of real-time images, at step 504, each set of real-time images may be analyzed based on the text label. In other words, each real-time image of the set of real-time images may be analyzed to identify the real-time image including the text label. In an embodiment, the text label may be received as the user input from the user. Further, based on the analysis of each of the set of real-time images, at step 506, the real-time image including the text label and the set of web elements may be selected from the set of real-time images. As will be appreciated, in some embodiment, the real-time image be provided as an input by the user along with the testcase.

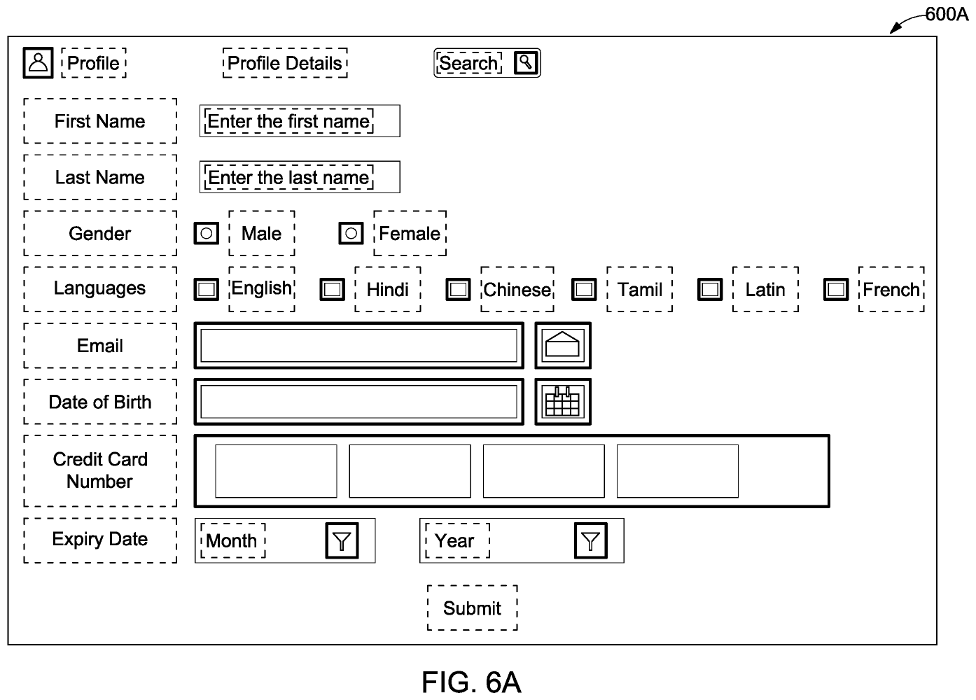

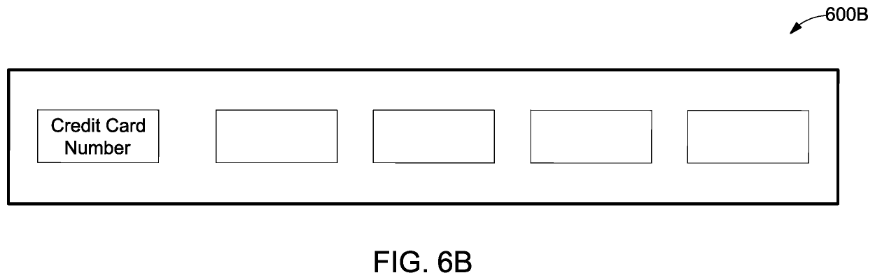

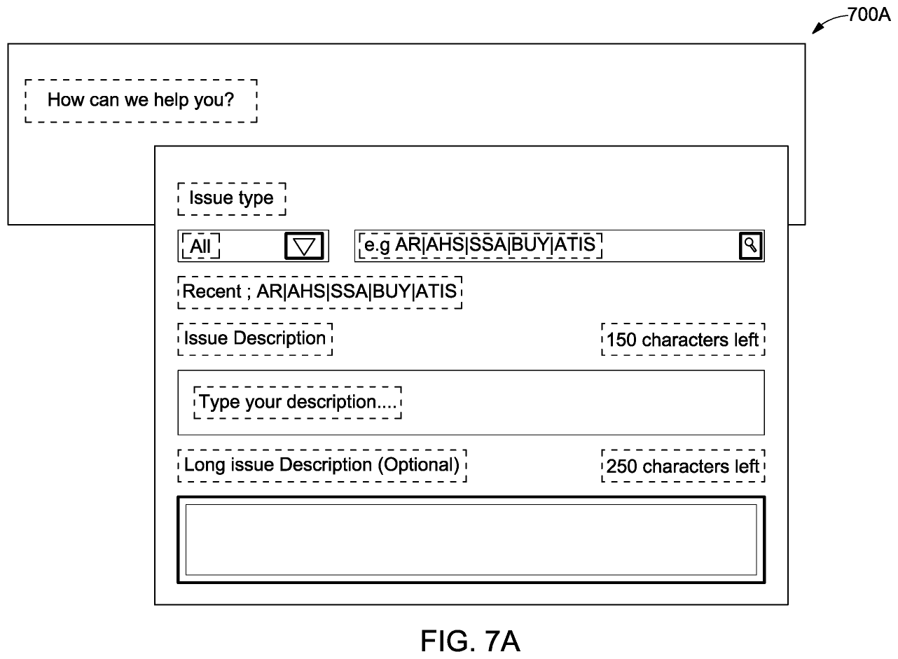

Referring now to FIG. 6A-6B, GUIs depicting generation of a segmented image is represented, in accordance with an exemplary embodiment of the present disclosure. FIGS. 6A and 6B are explained in conjunction with FIGS. 1-5.

In FIG. 6A, a set of text labels and a set of web elements within a real-time image of an application (e.g., the mobile application or the web application) is depicted via a GUI 600A. The real-time image may be of a payment page (webpage) of an application (e.g., a shopping application). Upon receiving the testcase, the text label may be identified within the testcase. It should be noted that the testcase may be received as the user input from the user. Once the text label is identified from the testcase, then the same text label may be identified within the real-time image. The method of identifying the text label from the testcase and the real-time has been already explained in detail in conjunction with FIG. 4. In order to identify the test label within the real-time image, each of the set of real-time images may be analyzed to select the real-time image including the text label. Further, based on the analysis, the real-time image including the text label may be selected. By way of an example, suppose the text label to be identified was ‘credit card number’. To identify the text label, the testcase may be analyzed. Further, based on the analysis once the text label is identified from the test case, each of the set of real-time images may be analyzed to identify ‘the credit card number’. For this, each real-time image including a set of text labels may be analyzed to identify the real-time image including the text label ‘credit card number’.

As depicted via the GUI 600A, the real-time image including the ‘credit card number’ may be selected. The real-time image may be selected based on analysis of the set of text labels within the real-time image. As depicted via the GUI 600A, the set of text labels may be ‘first name’, ‘last name’, ‘gender’, ‘email’, ‘date of birth’, ‘credit card number’, and ‘expiry date’. Further, in addition to above mentioned text labels, the set of text labels may also include each text label present in an inactive or a shadowed mode within the web element, for example, ‘enter the first name’, ‘enter the last name’, ‘month’, ‘year’, as depicted via the GUI 600A. Each of the set of text labels is highlighted using a dashed line. It should be noted that, in case of inactive or shadowed text label, the text label detection will be given higher precedence than the web element detection. In addition, the mapping algorithm may be configured in a way such that during mapping of the web element to the corresponding text label, the mapping algorithm may be able to accurately recognize that the text label is present within the web element. Once the text label is identified within the real-time image, then, a positioning of each of a set of web elements may be determined. The positioning, for example, may be a position of each web element, such as an icon, a button, a dropdown list, a checkbox, a text field, a text box, a radio button, a calendar, a text area, text links, etc., within the real-time image. The position identified for each web element is represented via a box highlighted using a bold line. Further, as depicted via the GUI 700A, the web elements corresponding to the text labels, i.e., ‘enter the first name’, ‘enter the last name’, ‘month’, ‘year’, are not highlighted via the bold lines as these text labels are given higher precedence over the corresponding web element of these text labels.

Further, based on the positioning, a web element corresponding to the text label ‘credit card number’ may be mapped to the text label, ‘credit card number’. The mapping may be done based on the set of text attributes associated with the text label and the set of web elements attributes associated with the web element. As will be appreciated the position of the web element associated with the text label ‘credit card number’ may be within a ROI of the text label.

As depicted via the GUI 600A, the web element of the credit card number may include a number of boxes. However, the trained AI model may be able be successfully map the text label, i.e., the credit card number to the corresponding web element irrespective of the number of boxes present within the web element. Further, based on mapping, the trained AI model may generate a segmented image as depicted via a GUI 600B of FIG. 6B. The generated segmented image may be provided as the input to the testing unit (i.e., the test automation framework).

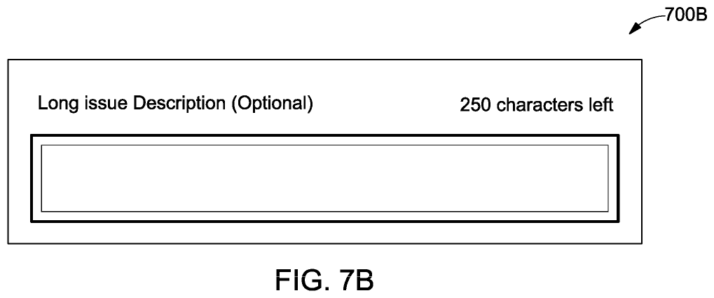

Referring now to FIG. 7A-7B, GUIs depicting generation of a segmented image is represented, in accordance with another exemplary embodiment of the present disclosure. FIGS. 7A and 7B are explained in conjunction with FIGS. 1-6B.

FIGS. 7A and 7B is another example of mapping a text label (i.e., long issue description (optional)) to a corresponding web element (i.e., a text area) present with a real-time image associated with ‘how can I help you?’ page (i.e., the webpage) of the shopping application. As explained in the FIGS. 1-6B, once the text label is identified from the testcase and the real-time image, then the positioning of the web elements may be identified within the real-time image by analysing each of a set of web elements present within the real-time image. In FIG. 7A, a GUI 700A may represent the real-time image. Further, text labels present within the real-time image may be, ‘how can we help you’, ‘issue type’, ‘all’, ‘e.g. AR|AHS|SSA|BUY|ATIS’, ‘Recent: AR, AHS, SSA, BUY, ATIS’, ‘Issue description’, ‘Type your description . . . ’, etc., as depicted via dashed lines in the GUI 700A. In addition, the positioning determined of each of a set of web elements present within the GUI 700A may be highlighted using bold lines. As already explained in FIG. 6A, text labels in the inactive or the shadowed mode will be given higher precedence over the corresponding web element. Therefore, as depicted via the GUI 700A, the web elements corresponding to the text labels, i.e., ‘all’, ‘e.g. AR|AHS|SSA|BUY|ATIS’, and ‘Type your description . . . ’ are not highlighted via the bold lines and these text labels are given higher precedence over the corresponding web element of these text labels.

Further, based on determined positioning of the web element, the text label, i.e., long issue description (optional) may be mapped to the web element, i.e., the text area based on a ROI of the text area to the long issue description (optional). Once the mapping is done, a segmented image including the text label, i.e., long issue description (optional) and the web element, i.e., the text area, may be generated as depicted via a GUI 700B of FIG. 7B.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

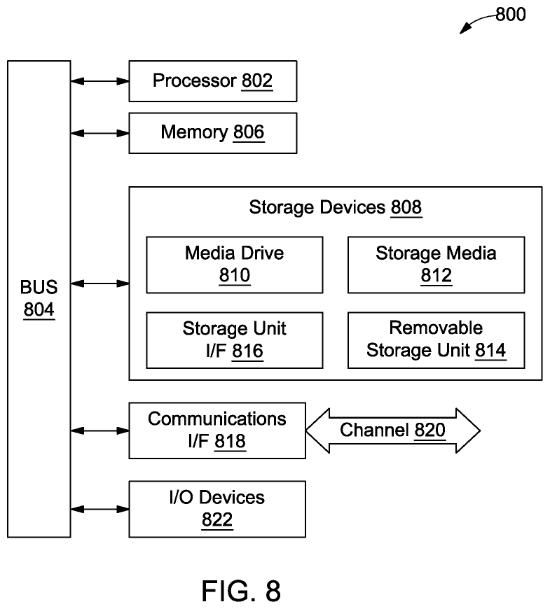

The disclosed methods and systems may be implemented on a conventional or a general-purpose computer system, such as a personal computer (PC) or server computer. Referring now to FIG. 8, an exemplary computing system 800 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 800 may represent, for example, a user device such as a desktop, a laptop, a mobile phone, personal entertainment device, DVR, and so on, or any other type of special or general-purpose computing device as may be desirable or appropriate for a given application or environment. The computing system 800 may include one or more processors, such as a processor 802 that may be implemented using a general or special purpose processing engine such as, for example, a microprocessor, microcontroller or other control logic. In this example, the processor 802 is connected to a bus 804 or other communication medium. In some embodiments, the processor 802 may be an Artificial Intelligence (AI) processor, which may be implemented as a Tensor Processing Unit (TPU), or a graphical processor unit, or a custom programmable solution Field-Programmable Gate Array (FPGA).

The computing system 800 may also include a memory 806 (main memory), for example, Random Access Memory (RAM) or other dynamic memory, for storing information and instructions to be executed by the processor 802. The memory 806 also may be used for storing temporary variables or other intermediate information during execution of instructions to be executed by the processor 802. The computing system 800 may likewise include a read only memory (“ROM”) or other static storage device coupled to bus 804 for storing static information and instructions for the processor 802.

The computing system 800 may also include storage devices 808, which may include, for example, a media drive 810 and a removable storage interface. The media drive 810 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 812 may include, for example, a hard disk, magnetic tape, flash drive, or other fixed or removable medium that is read by and written to by the media drive 810. As these examples illustrate, the storage media 812 may include a computer-readable storage medium having stored therein particular computer software or data.

In alternative embodiments, the storage devices 808 may include other similar instrumentalities for allowing computer programs or other instructions or data to be loaded into the computing system 800. Such instrumentalities may include, for example, a removable storage unit 814 and a storage unit interface 816, such as a program cartridge and cartridge interface, a removable memory (for example, a flash memory or other removable memory module) and memory slot, and other removable storage units and interfaces that allow software and data to be transferred from the removable storage unit 814 to the computing system 800.

The computing system 800 may also include a communications interface 818. The communications interface 818 may be used to allow software and data to be transferred between the computing system 800 and external devices. Examples of the communications interface 818 may include a network interface (such as an Ethernet or other NIC card), a communications port (such as for example, a USB port, a micro-USB port), Near field Communication (NFC), etc. Software and data transferred via the communications interface 818 are in the form of signals which may be electronic, electromagnetic, optical, or other signals capable of being received by the communications interface 818. These signals are provided to the communications interface 818 via a channel 820. The channel 820 may carry signals and may be implemented using a wireless medium, wire or cable, fiber optics, or other communications medium. Some examples of the channel 820 may include a phone line, a cellular phone link, an RF link, a Bluetooth link, a network interface, a local or wide area network, and other communications channels.

The computing system 800 may further include Input/Output (I/O) devices 822. Examples may include, but are not limited to a display, keypad, microphone, audio speakers, vibrating motor, LED lights, etc. The I/O devices 822 may receive input from a user and also display an output of the computation performed by the processor 802. In this document, the terms “computer program product” and “computer-readable medium” may be used generally to refer to media such as, for example, the memory 806, the storage devices 808, the removable storage unit 814, or signal(s) on the channel 820. These and other forms of computer-readable media may be involved in providing one or more sequences of one or more instructions to the processor 802 for execution. Such instructions, generally referred to as “computer program code” (which may be grouped in the form of computer programs or other groupings), when executed, enable the computing system 800 to perform features or functions of embodiments of the present invention.

In an embodiment where the elements are implemented using software, the software may be stored in a computer-readable medium and loaded into the computing system 800 using, for example, the removable storage unit 814, the media drive 810 or the communications interface 818. The control logic (in this example, software instructions or computer program code), when executed by the processor 802, causes the processor 802 to perform the functions of the invention as described herein.

Various embodiments provide a method and a system for managing applications. The disclosed method and system may identify, by a trained AI model, a text label from a testcase and a real-time image associated with an application. It may be noted that the application is one of the mobile application or a web application. Further, the disclosed method and system determine, by the trained AI model, a positioning of each of a set of web elements within the real-time image. The processor-executable instructions, on execution, may further cause the processor to map, by the trained AI model, the text label to a web element from the set of web elements based on the determined positioning using a mapping algorithm. It may be noted that the text label with the web element is mapped based on a corresponding set of attributes. Moreover, the disclosed method and system may generate, by the trained AI model, a segmented image including the text label and the web element, upon mapping. Thereafter, the disclosed method and system may transmit, by the trained AI model, the segmented image to a testing unit for performing an action associated with the text label and the web element.

Thus, the disclosed method and system try to overcome the technical problem of managing applications. The method and system enable identification of the unique element locator information of web elements using its associated text labels with the help of Artificial intelligence (AI) techniques. In other words, the disclosed method and system overcomes the challenges encountered in identifying the web elements for accessing icons, buttons, dropdown, radio buttons, iframes, search field, comment box, checkbox, dynamic objects, date picker etc., with traditional methods for the applications (i.e., the mobile or web applications). In addition, the disclosed method and system provides text label and its corresponding web element as an image thereby enabling easy access to the web elements for validations. The disclosed method and system may remove manual efforts in collecting the element locator information of web element. Moreover, the disclosed method and system may enable testers to overcome recurrent effort required in updating the path or web element information in testcases, whenever there is a change, or a new element is introduced in the application. The orientation of the text label or the web element does not hamper the identification of the text label along with its associated web element using the disclosed method and system. Further, the disclosed method and system may work as standalone system or can be integrated with any test automation frameworks for testing functionality of the web elements within the application, thereby reducing overall testing cycle time. Further, the disclosed method and system helps to achieve an additional 10%-15% automation which is not possible using the traditional automation frameworks.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described a method and system for managing applications. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for managing applications, the method comprising:
identifying, by a trained Artificial Intelligence (AI) model, a text label from a testcase and a real-time image associated with an application, wherein the application is one of the mobile application or a web application;
determining, by the trained AI model, a positioning of each of a set of web elements within the real-time image;
mapping, by the trained AI model, the text label to a web element from the set of web elements based on the determined positioning using a mapping algorithm, wherein the text label is mapped the web element based on a corresponding set of attributes;
generating, by the trained AI model, a segmented image comprising the text label and the web element, upon mapping; and
transmitting, by the trained AI model, the segmented image to a testing unit for performing an action associated with the text label and the web element.

2. The method of claim 1, wherein the corresponding set of attributes comprises a set of text attributes and a set of web elements attributes.

3. The method of claim 2, wherein the set of text attributes associated with the text label comprises an orientation of the text label, an alignment of the text label, font size, font color, and font style.

4. The method of claim 2, wherein identifying the text label comprises:
extracting the text label using a text recognition technique; and
validating the text label based on the set of text attributes using a text correction algorithm.

5. The method of claim 1, further comprising:
capturing a set of real-time images associated with a plurality of web pages of the application, wherein each of the set of real-time images may be captured based on test steps within the testcase;
analysing each of the set of real-time images based on the text label; and
selecting from the set of real-time images, the real-time image comprising the text label and the set of web elements, in response to analysing.

6. The method of claim 2, wherein the set of web elements attributes comprises a type of the web element, an alignment of the web element, an orientation of the web element, a size of the web element, a shape of the web element, number of blocks within the web element, background of the real-time image comprising the web element.

7. The method of claim 1, wherein mapping the text label to the web element comprises:
selecting the web element from the set of web elements based on the determined positioning and the set of web elements attributes, wherein a positioning of the web element is within a Region of Interest (ROI) associated with the text label.

8. A system for managing applications, the system comprising:
a processor; and
a memory communicatively coupled to the processor, wherein the memory stores processor instructions, which when executed by the processor, cause the processor to:
identify, by a trained Artificial Intelligence (AI) model, a text label from a testcase and a real-time image associated with an application, and wherein the application is one of the mobile application or a web application.
determine, by the trained AI model, a positioning of each of a set of web elements within the real-time image;
map, by the trained AI model, the text label to a web element from the set of web elements based on the determined positioning using a mapping algorithm, wherein the text label is mapped to the web element based on a corresponding set of attributes;
generate, by the trained AI model, a segmented image comprising the text label and the web element, upon mapping; and
transmit, by the trained AI model, the segmented image to a testing unit for performing an action associated with the text label and the web element.

9. The system of claim 8, wherein the corresponding set of attributes comprises a set of text attributes and a set of web elements attributes.

10. The system of claim 9, wherein the set of text attributes associated with the text label comprises an orientation of the text label, an alignment of the text label, font size, font color, and font style.

11. The system of claim 9, wherein, to identify the text label, the processor executable instructions further cause the processor to:
extract the text label using a text recognition technique; and
validate the text label based on the set of text attributes using a text correction algorithm.

12. The system of claim 8, wherein the processor executable instructions further cause the processor to:
capture a set of real-time images associated with a plurality of web pages of the application, wherein each of the set of real-time images may be captured based on test steps within the testcase;
analyse each of the set of real-time images based on the text label; and
select from the set of real-time images, the real-time image comprising the text label and the set of web elements, in response to analysing.

13. The system of claim 9, wherein the set of web elements attributes comprises a type of the web element, an alignment of the web element, an orientation of the web element, a size of the web element, a shape of the web element, number of blocks within the web element, background of the real-time image comprising the web element.

14. The system of claim 8, wherein, to map the text label to the web element, the processor executable instructions further cause the processor to:
select the web element from the set of web elements based on the determined positioning and the set of web elements attributes, wherein a positioning of the web element is within a Region of Interest (ROI) associated with the text label.

15. A non-transitory computer-readable medium storing computer-executable instructions for managing applications, the stored instructions, when executed by a processor, causes the processor to perform operations comprising:
identifying, by a trained Artificial Intelligence (AI) model, a text label from a testcase and a real-time image associated with an application, wherein the application is one of the mobile application or a web application;
determining, by the trained AI model, a positioning of each of a set of web elements within the real-time image;
mapping, by the trained AI model, the text label to a web element from the set of web elements based on the determined positioning using a mapping algorithm, wherein the text label is mapped to the web element based on a corresponding set of attributes;
generating, by the trained AI model, a segmented image comprising the text label and the web element, upon mapping; and
transmitting, by the trained AI model, the segmented image to a testing unit for performing an action associated with the text label and the web element.

16. The non-transitory computer-readable medium of claim 15, wherein the corresponding set of attributes comprises a set of text attributes and a set of web elements attributes.

17. The non-transitory computer-readable medium of claim 16, wherein the set of text attributes associated with the text label comprises an orientation of the text label, an alignment of the text label, font size, font color, and font style.

18. The non-transitory computer-readable medium of claim 16, wherein identifying the text label comprises:
extracting the text label using a text recognition technique; and
validating the text label based on the set of text attributes using a text correction algorithm.

19. The non-transitory computer-readable medium of claim 15, further comprising:
capturing a set of real-time images associated with a plurality of web pages of the application;
analysing each of the set of real-time images based on the text label; and selecting from the set of real-time images, the real-time image comprising the text label and the set of web elements, in response to analysing.

20. The non-transitory computer-readable medium of claim 16, wherein the set of web elements attributes comprises a type of the web element, an alignment of the web element, an orientation of the web element, a size of the web element, a shape of the web element, number of blocks within the web element, background of the real-time image comprising the web element.
